(19) United States
(12) Patent Application Publication
(10) Pub. No.: US 2024/0291521 A1
(43) Pub. Date: Aug. 29, 2024

(54) METHOD AND APPARATUS FOR COMMUNICATION VIA RECONFIGURABLE INTELLIGENT SURFACE

(71) Applicant: Electronics and Telecommunications Research Institute, Daejeon (KR)

(72) Inventors: Jun Hyeong KIM, Daejeon (KR); Il Gyu KIM, Daejeon (KR); Hee Sang CHUNG, Daejeon (KR); Sung Woo CHOI, Daejeon (KR)

(21) Appl. No.: 18/586,294

(22) Filed: Feb. 23, 2024

(30) Foreign Application Priority Data
Feb. 23, 2023 (KR) 10-2023-0024665
Feb. 1, 2024 (KR) 10-2024-0016261

(51) Int. Cl. H04B 7/04; H04B 17/318; H04W 72/231

(52) U.S. Cl. CPC H04B 7/04013; H04B 17/328; H04W 72/231

(57) ABSTRACT

A method performed by a base station may comprise: transmitting, to a first reconfigurable intelligent surface (RIS) node, first control information for the first RIS node; transmitting, to a terminal, first information of the first RIS node based on the first control information; and transmitting a first signal to the first RIS node and the terminal while the first RIS node is in an activated state according to the first control information, wherein the first signal is transmitted to the terminal through a path reaching the terminal from the base station via the first RIS node and a path directly reaching the terminal from the base station.

### CROSS-REFERENCE TO RELATED APPLICATIONS

This application claims priority to Korean Patent Applications No. 10-2023-0024665, filed on Feb. 23, 2023, and No. 10-2024-0016261, filed on Feb. 1, 2024, with the Korean Intellectual Property Office (KIPO), the entire contents of which are hereby incorporated by reference in their entireties.

### BACKGROUND

### 1. Technical Field

The disclosure generally relates to communication via a reconfigurable intelligent surface (RIS), that can enable a base station and a terminal to communicate using the RIS.

### 2. Related Art

With the development of information and communication technology, various wireless communication technologies have been developed. Typical wireless communication technologies include Long Term Evolution (LTE), New Radio (NR), 6th generation (6G) communication, among others. The LTE may be one of 4th generation (4G) wireless communication technologies, and the NR may be one of 5th generation (5G) wireless communication technologies.

In order to provide processing for the rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) is being considered, which uses a frequency band (e.g., a frequency band of 6 GHz or above) higher than that of the 4G communication system as well as a frequency band of the 4G communication system (e.g., a frequency band of 6 GHz or below). The 5G communication system may support enhanced Mobile BroadBand (eMBB), Ultra-Reliable and Low-Latency Communication (URLLC), and massive Machine Type Communication (mMTC).

Meanwhile, millimeter-wave (mmWave) communication may be one of the core technologies of the 5G communication system. The millimeter wave can achieve a high data rate and high spectral efficiency due to its wider signal bandwidth. However, the millimeter wave may suffer from significant path-loss and a blockage of the line of sight (LOS) between communication devices. A reconfigurable intelligent surface (RIS) may be a technology that can improve the performance of millimeter wave wireless communications. Elements of RIS can reflect, refract, absorb, or focus incoming waves toward a desired direction. This functionality can help overcome the problems mentioned above, including path attenuation and blockage along with millimeter-wave propagation conditions. However, channel estimation in RIS-aided communication may still be a major concern due to the passive nature of RIS elements and the estimation overhead that occurs in multiple-input multiple-output (MIMO) systems.

### SUMMARY

Exemplary embodiments of the present disclosure are directed to providing methods and apparatuses for communication via a RIS, which enables a base station and a terminal to communicate using the RIS.

According to a an embodiment of the present disclosure, a method performed by a base station may comprise: transmitting, to a first reconfigurable intelligent surface (RIS) node, first control information for the first RIS node; transmitting, to a terminal, first information of the first RIS node based on the first control information; and transmitting a first signal to the first RIS node and the terminal while the first RIS node is in an activated state according to the first control information, wherein the first signal is transmitted to the terminal through a path reaching the terminal from the base station via the first RIS node and a path directly reaching the terminal from the base station.

The first control information may include at least one of information on an identifier (ID) of the first RIS node, information on a start time of activation of the first RIS node, information on an activation periodicity of the first RIS node, information on an activation duration of the first RIS node, information on a start time of deactivation of the first RIS node, information on a deactivation periodicity of the first RIS node, information on a deactivation duration of the first RIS node, information on a reflection coefficient of the first RIS node, information indicating activation of one or more reflecting element of the first RIS node, information indicating deactivation of one or more reflecting element of the first RIS node, information on a beam width and a reflection direction of a reflected signal of the first RIS node, or information on a setting value for one or more activated reflecting element of the first RIS node.

The first information may include at least one of information on a start time of activation of the first RIS node, information on an activation periodicity of the first RIS node, information on an activation duration of the first RIS node, information on a start time of deactivation of the first RIS node, information on a deactivation periodicity of the first RIS node, or information on a deactivation duration of the first RIS node.

The information on the start time of activation of the first RIS node may include information on a reference time and information on an offset from the reference time.

The first control information is transmitted to the terminal through at least one of radio resource control (RRC) signaling, a medium access control (MAC) control element (CE) message, or downlink control information (DCI).

The method may further comprise: setting a time when the first RIS node is in a deactivated state; transmitting, to the first RIS node, second control information on the time when the first RIS node is in the deactivated state; transmitting, to the terminal, second information of the first RIS node based on the second control information; and transmitting a second signal to the terminal while the first RIS node is in the deactivated state, wherein the second signal is transmitted to the terminal through a path directly reaching the terminal from the base station.

The method may further comprise: transmitting a third signal to a second RIS node and the terminal while the first RIS node is in a deactivated state and the second RIS node is in an activated state, wherein the third signal is transmitted to the terminal through a path directly reaching the terminal from the base station and a path reaching the terminal via the second RIS node.

The method may further comprise: receiving, from the terminal, information on a first signal strength for the first signal and information on a second signal strength for the third signal; and changing a serving RIS from the first RIS node to the second RIS node based on the first signal strength and the second signal strength.

The method may further comprise: transmitting the first signal to a second RIS node while the first RIS node is in an activated state, wherein the first signal is transmitted to the terminal through a path via the first RIS node, a path via the second RIS node, and a path directly reaching the terminal; transmitting a fourth signal to the terminal while the first RIS node and the second RIS node are in deactivated states; and transmitting a fifth signal to the second RIS node and the terminal while the first RIS node is in a deactivated state and the second RIS node is in an activated state, wherein the fifth signal is received by the terminal through a path directly reaching the terminal from the base station and a path reaching the terminal via the second RIS node.

The method may further comprise: receiving, from the terminal, information on a third signal strength for the first signal based on at least one of the first signal, the fourth signal, or the fifth signal, and information on a fourth signal strength for the fifth signal based on at least one of the fourth signal or the fifth signal; and changing a serving RIS from the first RIS node to the second RIS node based on the third signal strength and the fourth signal strength.

According to another embodiment of the present disclosure, a method of a terminal may comprise: receiving, from a base station, first information of a first reconfigurable intelligent surface (RIS) node; receiving a first reception signal from the first RIS node and the base station while the first RIS node is in an activated state based on the first information; receiving a second reception signal from the base station while the first RIS node is in a deactivated state; calculating a first received signal strength based on the first reception signal and the second reception signal; and transmitting information on the calculated first received signal strength to the base station, wherein the first reception signal is a first signal transmitted by the base station, that is received through a path reaching the terminal from the base station via the first RIS node and a path directly reaching the terminal from the base station, and the second reception signal is second signal transmitted by the base station, that is received through a path directly reaching the terminal from the base station.

The first received signal strength may be the strength of a signal obtained by subtracting the second reception signal from the first reception signal.

The first information may include at least one of information on a start time of activation of the first RIS node, information on an activation periodicity of the first RIS node, information on an activation duration of the first RIS node, information on a start time of deactivation of the first RIS node, information on a deactivation periodicity of the first RIS node, or information on a deactivation duration of the first RIS node.

The method may further comprise: receiving a third reception signal from the first RIS node, a second RIS node, and the base station while the first RIS node and the second RIS node are in activated states; receiving a fourth reception signal from the second RIS node and the base station while the first RIS node is in a deactivated state and the second RIS node is in an activated state; receiving a fifth reception signal from the base station while the first RIS node and the second RIS node are in deactivated states; calculating a second received signal strength by considering at least one of the first reception signal, the third reception signal, the fourth reception signal, or the fifth reception signal; calculating a third received signal strength by considering at least one of the fourth reception signal or the fifth reception signal; and transmitting information on the second received signal strength and the third received signal strength to the base station, wherein the third reception signal is a third signal transmitted by the base station, which is received by the terminal through a path via the first RIS node, a path via the second RIS node, and a path directly reaching the terminal from the base station, the fourth reception signal is a fourth signal transmitted by the base station, which is received through a path via the second RIS node and a path directly reaching the terminal from the base station, and the fifth reception signal is a fifth signal transmitted by the base station, which is received through a path directly reaching the terminal from the base station.

According to yet another embodiment of the present disclosure, a terminal for facilitating communication in a wireless network, the terminal comprising a memory; and a processor coupled to the memory, the processor configured to cause: receiving, from a base station, first information of a first reconfigurable intelligent surface (RIS) node; receiving a first reception signal from the first RIS node and the base station while the first RIS node is in an activated state based on the first information; receiving a second reception signal from the base station while the first RIS node is in a deactivated state; calculating a first received signal strength by considering the first reception signal and the second reception signal; and transmitting information on the calculated first received signal strength to the base station, wherein the first reception signal is a first signal transmitted by the base station, which is received through a path reaching the terminal from the base station via the first RIS node and a path directly reaching the terminal from the base station, and the second reception signal is a second signal transmitted by the base station, which is received through a path directly reaching the terminal from the base station.

The first received signal strength may be the strength of a signal obtained by subtracting the second reception signal from the first reception signal.

The first information may include at least one of information on a start time of activation of the first RIS node, information on an activation periodicity of the first RIS node, information on an activation duration of the first RIS node, information on a start time of deactivation of the first RIS node, information on a deactivation periodicity of the first RIS node, or information on a deactivation duration of the first RIS node.

The processor is further configured to cause: receiving a third reception signal from the first RIS node, a second RIS node, and the base station while the first RIS node and the second RIS node are in activated states; receiving a fourth reception signal from the second RIS node and the base station while the first RIS node is in a deactivated state and the second RIS node is in an activated state; receiving a fifth reception signal from the base station while the first RIS node and the second RIS node are in deactivated states; calculating a second received signal strength by considering at least one of the first reception signal, the third reception signal, the fourth reception signal, or the fifth reception signal; calculating a third received signal strength by considering at least one of the fourth reception signal or the fifth reception signal; and transmitting information on the second received signal strength and the third received signal strength to the base station, wherein the third reception signal is a third signal transmitted by the base station, which is received by the terminal through a path via the first RIS node, a path via the second RIS node, and a path directly reaching the terminal from the base station, the fourth reception signal is a fourth signal transmitted by the base station, which is received through a path via the second RIS node and a path directly reaching the terminal from the base station, and the fifth reception signal is a fifth signal transmitted by the base station, which is received through a path directly reaching the terminal from the base station.

According to the present disclosure, the base station can control RISs by providing activation control information for each RIS to a corresponding RIS controller. Further, the base station can transmit a signal to the terminal via the RIS and receive information on a measured received signal strength from the terminal.

### BRIEF DESCRIPTION OF DRAWINGS

FIG. 1 is a conceptual diagram illustrating a communication system in accordance with an embodiment.

FIG. 2 is a block diagram illustrating a communication node constituting a communication system in accordance with an embodiment.

FIG. 3 is a conceptual diagram illustrating a communication system supporting a reconfigurable intelligent surface in accordance with an embodiment.

FIG. 4 is a conceptual diagram illustrating a relay system based on a network-controlled repeater in accordance with an embodiment.

FIG. 5 is a conceptual diagram illustrating a relay system based on a reconfigurable intelligent surface in accordance with an embodiment.

FIG. 6 is a conceptual diagram illustrating communication device(s) using reconfigurable intelligent surfaces in accordance with an embodiment.

FIG. 7 is a conceptual diagram illustrating periodic state change of a reconfigurable intelligent surface in accordance with an embodiment.

FIG. 8 is a conceptual diagram illustrating aperiodic state change of a reconfigurable intelligent surface in accordance with an embodiment.

FIG. 9 is a conceptual diagram illustrating aperiodic state change of a reconfigurable intelligent surface in accordance with an embodiment.

FIG. 10 is a sequence diagram illustrating a communication method through a reconfigurable intelligent surface in accordance with an embodiment.

FIG. 11 is a conceptual diagram illustrating a method for grouping terminals and allocating reconfigurable intelligent surfaces in accordance with an embodiment.

FIG. 12 is a conceptual diagram illustrating aperiodic state change of a reconfigurable intelligent surface in accordance with an embodiment.

FIG. 13 is a conceptual diagram a method for allocating a transmission beam and a reconfigurable intelligent surface for each synchronization signal block in accordance with an embodiment.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”. A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

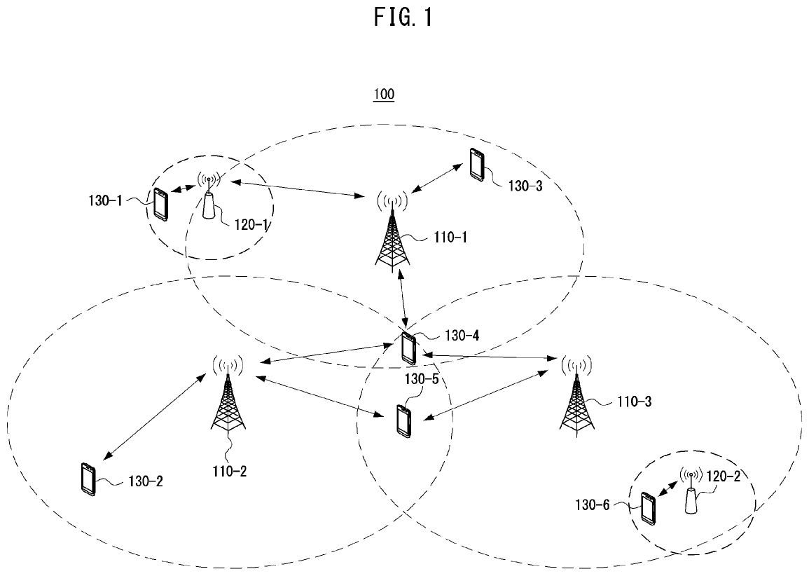

FIG. 1 is a conceptual diagram illustrating a communication system in accordance with an embodiment.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single-carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

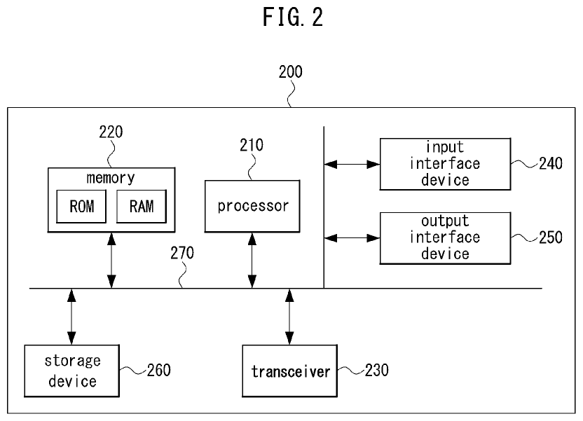

FIG. 2 is a block diagram illustrating a communication node constituting a communication system in accordance with an embodiment.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. In many embodiments, the respective components included in the communication node 200 may not be connected to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may include one or more volatile storage mediums and/or a non-volatile storage mediums. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), relay node, or the like. Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, millimeter-wave (mmWave) communication may be one of the core technologies of the 5G communication system. The millimeter wave can achieve a high data rate and high spectral efficiency due to its wider signal bandwidth. However, the millimeter wave may suffer from a significant path-loss and a blockage of line of sight (LOS) between communication devices. A reconfigurable intelligent surface (RIS) may be a technology to improve the performance of millimeter wave wireless communications.

In particular, RIS can improve spectrum and energy efficiency of a radio network by artificially reconfiguring an electromagnetic wave propagation environment, and may be a promising candidate technology for 5G-Advanced and 6G. The reflecting elements of the RIS can enhance a received signal strength by appropriately adjusting a phase of an incident signal to reflect it and combining the reflected signal with a direct-path signal. In addition, these reflecting elements of the RIS can mitigate signal interference by appropriately adjusting the phase of the incident signal to reflect it and combining the reflected signal with the direct-path signal.

In particular, in 5G/6G communication systems that use a high frequency band such as a millimeter wave band, direct-path signals may be blocked by obstacles. In many embodiments, the reflecting elements of the RIS can maintain smooth communication by directing a reflected beam in a desired direction with low power consumption.

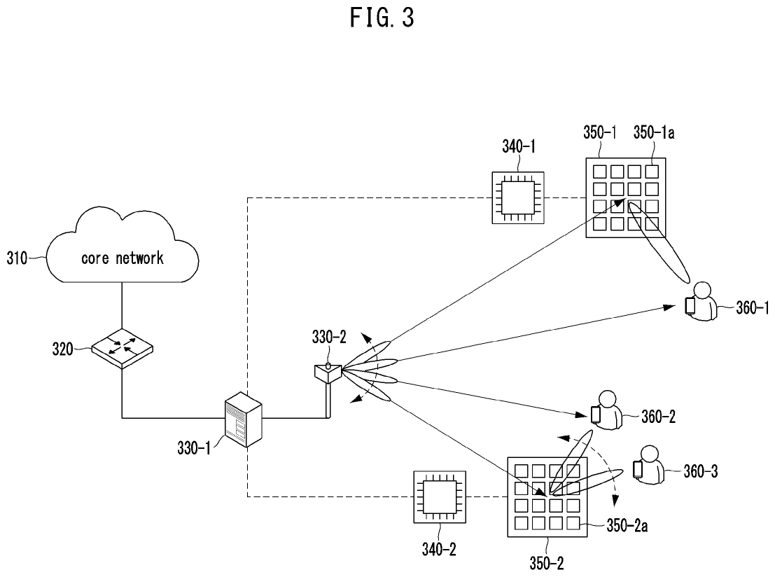

FIG. 3 is a conceptual diagram illustrating a communication system supporting a reconfigurable intelligent surface in accordance with an embodiment.

Referring to FIG. 3, a communication system may include a core network 310, a gateway 320, a base station central unit (CU) 330-1, a base station distributed unit (DU) 330-2, a plurality of RIS controllers 340-1 and 340-2, a plurality of RISs 350-1 and 350-2, a plurality of terminals 360-1, 360-2, and 360-3, and the like. Here, each of the plurality of RISs 350-1 and 350-2 may include a plurality of reflecting elements 350-1a and 350-2a. Here, the base station CU 330-1 and the base station DU 330-2 may provide a base station.

In such the communication system, each of the plurality of RIS controllers may be connected to the base station CU through a wired or wireless control link. In addition, each of the plurality of RIS controllers may reflect a downlink (DL) signal incident on the reflecting elements of the corresponding RIS to the terminal by appropriately adjusting phases of the reflecting elements under control of the base station CU. In addition, each of the plurality of RIS controllers may reflect an uplink (UL) signal incident on the reflecting elements of the corresponding RIS to the base station DU by appropriately adjusting phases of the reflecting elements under control of the base station CU.

Since RIS may only serve to reflect signals by adjusting the phases of the reflecting elements without elaborate signal processing as described herein, it may have several advantages compared to the conventional relay scheme.

1. The RIS may be easy to install. Due to the passive characteristics of the reflecting elements, the RIS may be manufactured with light weight and thinness. Accordingly, the RIS can be easily installed on various objects such as building surfaces, ceilings, signboards, streets, etc., allowing the RIS to be installed almost anywhere.

2. The RIS may be cost-and power-efficient. The RIS may not require an analog to digital converter (AD), digital to analog converter (DAC), power amplifier, and/or the like. Accordingly, a communication system using the RIS may operate at a much lower cost in terms of hardware and power consumption compared to existing communication systems.

3. The RIS may support a full-duplex (FD) mode. Since the RIS only reflects electromagnetic waves, it may not generate self-interference or thermal noises, so it can support FD transmission. In addition, RIS may have a lower signal processing complexity than FD relays which require sophisticated self-interference cancellation techniques, and can achieve a higher spectral efficiency than half-duplex (HD) relays.

4. A power gain of the RIS may follow a second-order scaling law, in contrast to a linear power scaling law of the conventional active antenna array.

Due to the above-described advantages, various communication network designs using the RIS are currently being considered. A millimeter wave communication network using the RIS may be an example. The millimeter wave communication can support a high transmission rate thanks to a wide available bandwidth. However, the millimeter wave communication may be vulnerable to a serious path loss that occurs in a high frequency band such as a millimeter wave band and signal blockage by obstacles such as cars, pedestrians, and trees.

The high path loss in the millimeter wave wireless communication may be mitigated by a high antenna gain achieved by deploying multiple antenna arrays in a small space thanks to a short wavelength of the millimeter wave. However, the problem of signal blockage by obstacles may not be solved in the millimeter wave wireless communication. The RIS may be used as a means to solve the signal blockage problem. The communication system may establish a secondary link between a transmitter and a receiver by arranging the RIS at an appropriate location between the transmitter and the receiver. This allows continuous communication through the secondary link if a direct link is blocked by an obstacle.

Meanwhile, academia and industry are currently conducting extensive research on discovering core technologies and use cases of RIS, aiming to address these various technical challenges. However, global standardization of RIS is still in its early stages. Recently, the European Telecommunications Standards Institute (ETSI) launched a new industry specification group (ISG), ISG_RIS, to review and establish global standardization for RIS technology. Since its kick-off meeting on Sep. 30, 2021, ISG_RIS has been identifying and defining RIS-related use cases, deployment scenarios, and related requirements. It is actively progressing standardization activities with the goal of addressing various technical challenges that may arise when implementing RIS in various areas, including fixed/mobile wireless access networks, fronthaul, backhaul, and the like.

In order to secure reliable coverage in cellular communication, a mobile communication operator may utilize various types of network nodes. For this purpose, the mobile communication operator may additionally deploy full-stack base stations. These full-stack base stations can extend coverage and prevent coverage holes. However, additional full-stack base stations may not be cost-effective, and installation may not be possible in some areas due to lack of available wired backhaul. Accordingly, in order to solve the above problems and improve network deployment flexibility, network nodes such as integrated access and backhaul (IAB) and radio frequency (RF) repeaters are being considered. The IAB has been introduced in the 3GPP release 16 (Rel-16) as a network node that does not require wired backhaul, and its functionality has been improved through standardization works in the 3GPP release 17 (Rel-17). The RF repeater may be a cost-effective solution that is already widely used in the 2G, 3G, and 4G systems to supplement coverage of a typical full-stack base station in a simple scheme of amplifying and forwarding (AF) received signals. In the 5G NR release-17, a radio access network (RAN) working group 4 (RAN4) has specified RF and electromagnetic compatibility (EMC) requirements for RF repeaters in frequency range (FR) 1 and FR 2 bands.

Recently, 3GPP has been undertaking standardization efforts for network-controlled repeaters (NCRs) with enhanced performance compared to RF repeaters, which transmit signals using the simple AF scheme. These efforts are being led by RAN 1 and began with the RAN1 #110bis-e meeting in October 2022.

The NR NCR has the capability to receive and process control information from the network, enabling more efficient AF operations compared to existing RF repeaters. Through this capability, the network can gain benefits such as mitigating unnecessary noise amplification, transmitting and receiving signals through beamforming in a specific direction, and simplifying network integration.

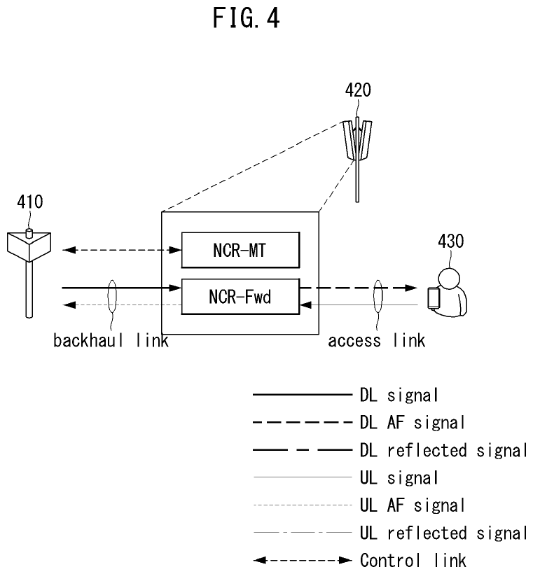

FIG. 4 is a conceptual diagram illustrating a relay system based on a network-controlled repeater in accordance with an embodiment.

Referring to FIG. 4, a relay system may include a base station 410, a network-controlled repeater (NCR) 420, a terminal 430, among other components. Here, the NCR 420 may be composed of an NCR-mobile-termination (MT) and NCR-forwarding (Fwd). The NCR-MT may be responsible for exchanging control information (e.g. control information for controlling the NCR-Fwd) by communicating with the base station through a control link based on an NR Uu interface. The NCR-Fwd may be responsible for receiving control information from the base station and performing AF on UL/DL RF signals according to the received control information.

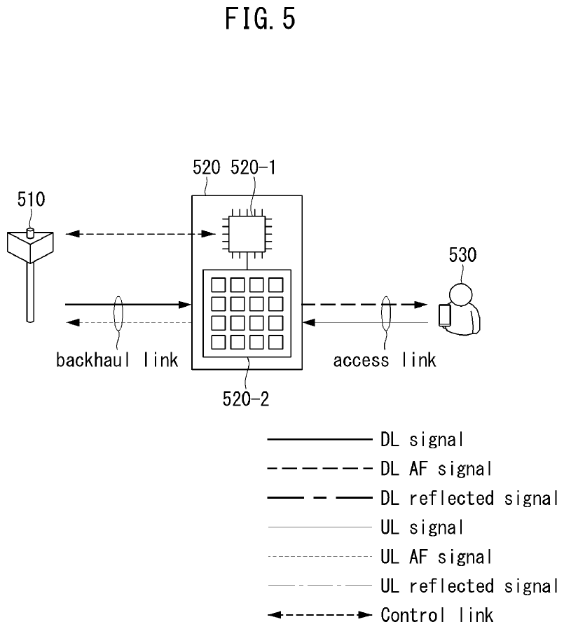

FIG. 5 is a conceptual diagram illustrating a relay system based on a reconfigurable intelligent surface in accordance with an embodiment.

Referring to FIG. 5, a relay system may include a base station 510, an RIS-based relay 520, a terminal 530, among other components. Here, the RIS-based relay 520 may be composed of an RIS controller 520-1 and an RIS 520-2.

Similarly to the NCR, the RIS-based relay system can reflect DL or UL signals incident on a reflective surface of the RIS to the base station or terminal by appropriately adjusting values of reflecting elements of the RIS under control of the base station through a control link.

The control link of the RIS may incorporate a wireless control link similar to that of the NCR. However, unlike the control links of relays, the control link of the RIS generally needs to be cost-and power-efficient. Therefore, a wired control link that does not require a receiving module may be preferred as a separate RIS control link. However, the RIS may be connected by wire to a fixed relay installed around the base station or a mobile relay within coverage of the bae station. In many embodiments, the base station may transmit control information to the fixed or mobile relay through a wireless link, and then, the relay may control the RIS according to the control information received from the base station. Accordingly, RIS control and RIS mobility through wireless links may also need to be considered during future standardization work.

Meanwhile, the NCR of 3GPP Rel-18 may have many aspects in common with the RIS, which is expected to be implemented after the 3GPP release-19 (Rel-19). The Rel-19 is the last release of 5G-Advanced before the launch of 6G, and started in September 2023 and ends in March 2025. Unlike conventional RF repeaters that simply radiate signals in all directions, the NCR, based on control information received from the base station through a control link, can perform a function of an in-band repeater, transmitting beams in a specific direction. This capability could be considered the most significant feature of NCR. The NCR can receive control information from the base station through a control link and, based on the received control information, reflect and transmit signals of the base station in the appropriate direction for specific users. The characteristics of NCR may conceptually resemble the core features of RIS. Therefore, based on the standardization efforts underway for NCRs in Rel-18, the direction of standardization for RIS may be anticipated.

Currently, the standardization work for NR NCR WI involves designing specifications for various side control information (SCI) signaling needed to control NCR from the base station and methods for NCR management. This NR NCR WI is proceeding based on several fundamental assumptions outlined below.

1. NCR is an in-band RF repeater used to extend network coverage in FR1 and FR2 bands based on the NCR model in TR38.867.

2. Only a single-hop fixed NCR is considered.

3. From the terminal's perspective, NCR is designed to be transparent.

4. NCR can simultaneously maintain a base station-NCR link and NCR-terminal link. In addition, NR NCR WI includes several objectives below.

1. Define signaling and related operations of SCI (e.g. beamforming, UL-DL TDD operation, ON-OFF information) for controlling NCR-Fwd

2. Define control plane signaling and related procedures

3. Define NCR management solution (identification and approval/verification of NCR)

4. Study RRM capabilities and, if necessary, define RRM requirements for NCR-MT

5. Study and define NCR's RF and EMC requirements, if necessary

The fundamental assumptions and objectives of the ongoing NCR WI standardization are expected to be applied quite similarly in future RIS standardization. Moreover, the future standardization direction for NCR may highly likely proceed with consideration for forward compatibility with RIS specifications. In particular, the basic control information signaling and related procedures defined in the Rel-18 NCR may be anticipated to serve as a baseline for the design of future RIS relay specifications.

The present disclosure aims to provide methods and apparatuses of communication and signaling in a wireless network supporting RISs. Hereinafter, in describing the present disclosure, ‘configuration’ may include both configuration or pre-configuration. In addition, although the present disclosure makes description by taking communication between a base station and a terminal as an example, exemplary embodiments of the present disclosure may be equally applied to other communication systems such as direct communication between terminals. In addition, in the present disclosure, the base station may be an entity that controls the RIS through a wired or wireless control link. On the other hand, the entity that controls the RIS may be equally changed from the base station to the terminal. In other words, the terminal may control the RIS and communicate with the base station according to methods described in the present disclosure.

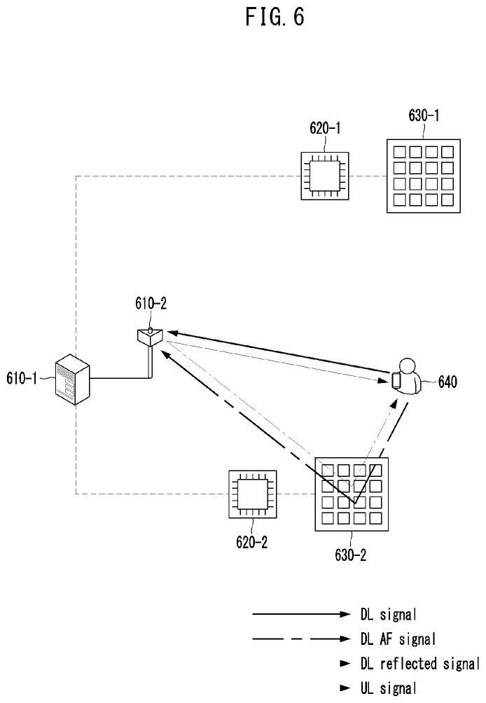

FIG. 6 is a conceptual diagram illustrating communication device(s) using reconfigurable intelligent surfaces in accordance with an embodiment.

Referring to FIG. 6, communication devices may include a base station CU 610-1, a base station DU 610-2, a plurality of RIS controllers 620-1 and 620-2, a plurality of RISs 630-1 and 630-2, a terminal 640, and the like. Here, each of the plurality of RISs 630-1 and 630-2 may include a plurality of reflecting elements. In addition, the base station CU 610-1 and the base station DU 610-2 may provide a base station. Further, a RIS controller and a corresponding RIS may be referred to as ‘RIS node’.

The terminal may determine its location using GPS satellites, or the like, and the terminal may report its location to the base station. Then, the base station may identify the location of the terminal by receiving information on the location of the terminal from the terminal. Accordingly, the base station may allocate a RIS to be used for communication with the terminal. In addition, the base station may inform the terminal of an ID (i.e. RIS ID) of the RIS allocated to the terminal. The terminal may receive and manage information on the RIS ID of the RIS allocated by the base station.

Meanwhile, the base station CU may transmit control information (i.e. activation control information) for configuring an activation state for each frequency band supported by the RIS corresponding to each of the RIS controllers through a wired or wireless control link. Then, each of the RIS controllers may receive the control information for configuring the activation state for each frequency band supported by the RIS from the base station CU.

When transmitting the activation control information to each of the RIS controllers through a wireless control link, the base station CU may use radio resource control (RRC) signaling, MAC CE message, and/or downlink control information (DCI), among others. However, exemplary embodiments of the present disclosure are not limited thereto. The activation control information for each frequency band transmitted to each of the RIS controllers may include one or more of the following.

a) The activation control information may include the RIS ID of the RIS.

b) The activation control information may include activation information of the RIS node. Here, the activation information of the RIS node may include information on an activation periodicity of the RIS node and information on an activation duration of the RIS node.

c) The activation control information may include deactivation information of the RIS node. Here, the deactivation information of the RIS node may include information on a deactivation periodicity of the RIS node and information on a deactivation duration of the RIS node.

d) The activation control information may include information on an application time of activation indication. Here, the information on the application time may be, for example, a difference between a slot index at a time when the base station CU indicates activation to the RIS controller and a slot index at a time when the transmitted activation indication is applied.

e) The activation control information may include information on an application time of deactivation indication. Here, the information on the application time may be, for example, a difference between a slot index at a time when the base station CU indicates deactivation to the RIS controller and a slot index at a time when the transmitted deactivation indication is applied.

f) The activation control information may include information on a reflection coefficient of the RIS. The base station CU may adjust a power of signals reflected by the RIS by adjusting the reflection coefficient of the RIS. For example, the reflection coefficient may be set to a value (e.g., a value between 0 and 1) representing the actual reflected signal power compared to the maximum power that can be reflected. The RIS configured with a reflection coefficient of 1 can reflect received signals at the maximum reflection power. In addition, the RIS configured with a reflection coefficient of 0.5 can reflect received signals at half the maximum reflection power.

g) The activation control information may include activation information for each reflecting element of the RIS. This control information may be information used to control each of the reflecting elements of the RIS. According to this control information, the RIS controller may activate only some reflecting elements of the RIS to form reflected beams of various beam widths and shapes.

h) The activation control information may include deactivation information for each reflecting element of the RIS. This control information may be information used to control each of the reflecting elements of the RIS. According to this control information, the RIS controller may deactivate only some reflecting elements of the RIS to form reflected beams of various beam widths and shapes.

i) The activation control information may include information on a beam width and a reflection direction of a reflected signal of the RIS.

j) The activation control information may include information on a setting value (e.g. phase value) for each activated reflecting element of the RIS.

Accordingly, the RIS controller may (re)configure the state of each frequency band of the RIS according to the activation control information received from the base station CU.

Meanwhile, the base station CU 610-1 may transmit information on the activation or deactivation states of RISs deployed within a serving cell to the terminal 640 through the base station DU 610-2. Then, the terminal 640 may receive the information on the activation or deactivation states of RISs from the base station CU 610-1 through the base station DU 610-2.

In many embodiments, the information on the activation states of the RISs may include information on a start time of activation, information on an activation periodicity, information on an activation duration, and the like for each RIS. The information on the deactivation states of the RISs may include information on a start time of deactivation, information on a deactivation periodicity, information on a deactivation duration, and the like for each RIS. Here, the base station CU 610-1 may use at least one of RRC signaling, MAC CE, DCI, and the like as a message delivering such the information, without being limited thereto. Here, the start time of activation (or deactivation) of the RIS may be defined by a reference time and an offset value from the reference time.

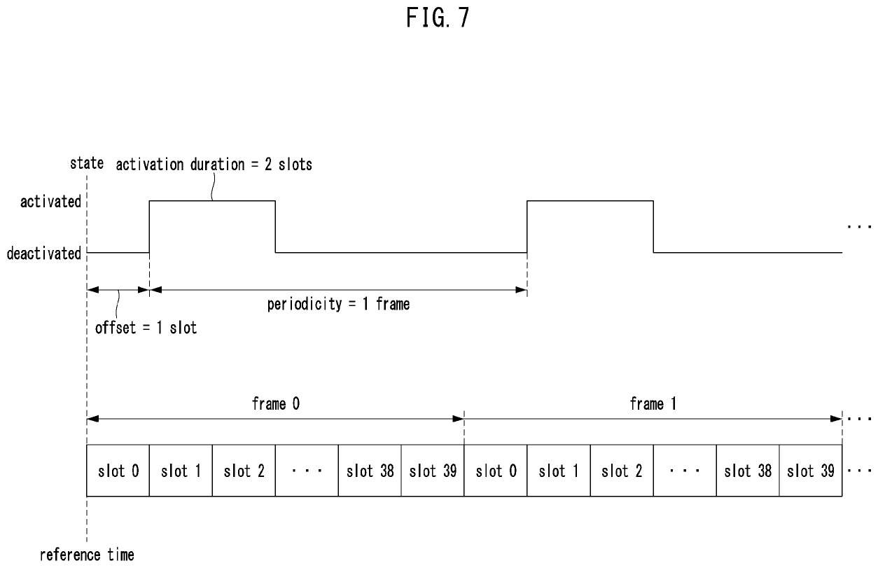

FIG. 7 is a conceptual diagram illustrating periodic state change of a reconfigurable intelligent surface in accordance with an embodiment.

Referring to FIG. 7, a frame 0, a frame 1, and the like may be located continuously from a reference time in the time domain. Here, the reference time may be a start time of slot 0 of frame 0. Further, an activation start offset may be one slot, an activation periodicity may be one frame, and an activation duration may be two slots. In many embodiments, the terminal may identify that the RIS allocated to itself is activated in slots 1 and 2 in frame 0. Here, a time unit for the activation start offset value, activation periodicity, and activation duration may be a slot, which may be milliseconds (ms), symbols, frames, or the like.

To support various mobility environments of the terminal, the base station may reconfigure the activation (or deactivation) periodicity. For example, if the terminal moves at high speed, the base station may (re)configure the activation (or deactivation) periodicity to be short. In contrast, if the terminal moves at low speed, the base station may (re) configure the periodicity to be long.

Referring again to FIG. 6, the base station may generate a reference signal by considering the RIS ID of the RIS allocated for communication with the terminal and the activation state of the corresponding RIS. Here, the base station CU may generate a scrambling sequence used to generate the reference signal according to the RIS ID of the RIS. The base station CU may generate a reference signal transmitted in an RIS activation period (i.e. period in which the RIS is activated) and a reference signal transmitted in an RIS deactivation period (i.e. period in which the RIS is deactivated) using different frequencies, times, or code resources. The base station CU may allocate guard symbol(s) to a boundary where the state of the RIS changes. Additionally, the base station CU may inform the terminal whether guard symbol(s) are actually allocated through RRC signaling, MAC CE, DCI, and/or the like.

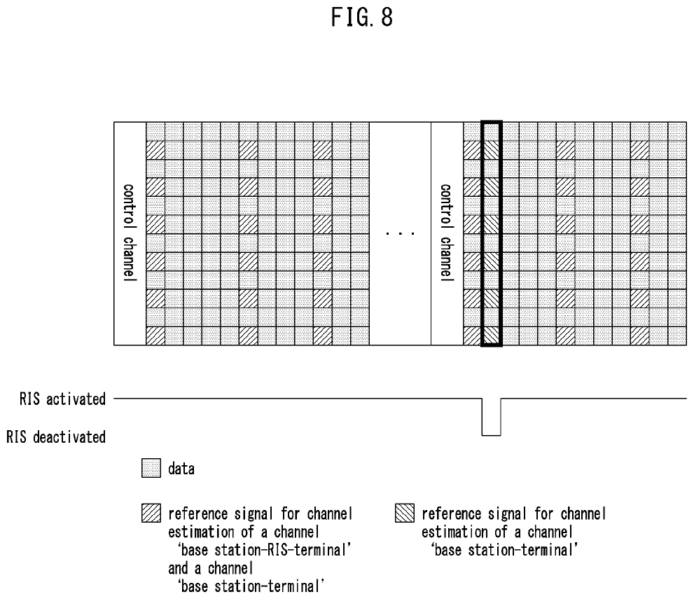

FIG. 8 is a conceptual diagram illustrating aperiodic state change of a reconfigurable intelligent surface in accordance with an embodiment.

Referring to FIG. 8, during the activation period of the RIS, the base station CU may aperiodically configure the RIS to a deactivated state during a specific slot or some symbols within a specific slot in order to separately estimate channels for a direct link and a reflected link. In many embodiments, when transitioning the RIS to a deactivated state during a specific slot or some symbols within a specific slot, the base station CU may inform the terminal of this through control information or MAC CE.

When the base station CU aperiodically configures the RIS to a deactivated state during a specific slot or some symbols within a specific slot, a method of informing this using control information may be implemented according to an exemplary embodiment below, but may not be limited thereto.

The base station CU may define a new control information format (e.g. new DCI format) indicating a deactivated state of the RIS. The terminal may detect the control information format for RIS deactivation, which may be transmitted by the base station, through blind detection. Accordingly, the terminal may identify that the RIS is to be deactivated during the entire period or some symbols of a slot in which the control information format is received or during the entire period or some symbols of a slot after a few slots from the slot in which the control information format is received. The terminal may identify various information on the deactivated state of the RIS, including the location of the deactivation slot (i.e. a slot in which the RIS is deactivated) and the location and number of the deactivation symbol(s) (i.e. symbol(s) in which the RIS is deactivated), through RIS deactivation control information obtained by demodulating the corresponding control information format. Here, the reference signal may include a demodulation reference signal (DMRS) for channel estimation, a channel state information reference signal (CSI-RS), a synchronization signal, and/or the like.

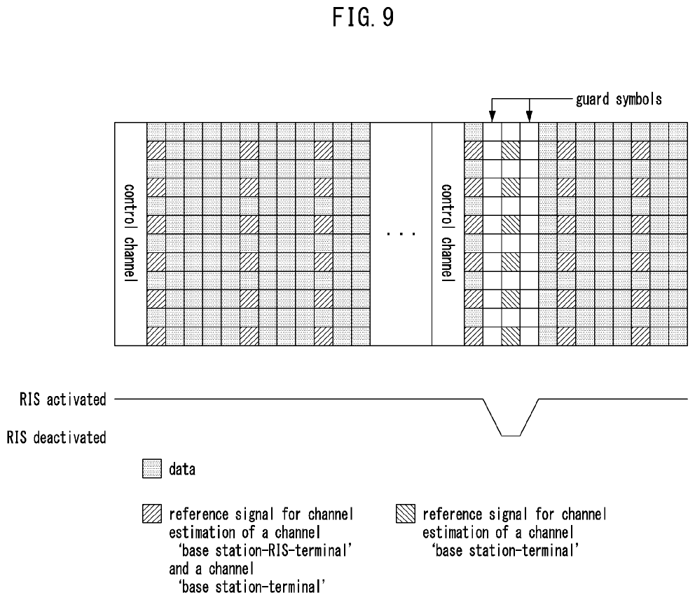

FIG. 9 is a conceptual diagram illustrating aperiodic state change of a reconfigurable intelligent surface in accordance with an embodiment.

Referring to FIG. 9, during the activation period of the RIS, the base station CU may aperiodically configure the RIS to a deactivated state during a specific slot or some symbols within a specific slot in order to separately estimate channels for a direct link and a reflected link. If a time required for the RIS state switching cannot be covered by a cyclic prefix (CP), the base station CU may additionally allocate a guard symbol.

The base station CU may inform the terminal of an allocation state and location of RIS deactivation symbols, including additional reference signal(s) and guard symbol within the slot, through control information (e.g. DCI) carried on a control channel. As an example, the base station CU may inform the terminal of the allocation state of the RIS deactivation symbols within the slot in a bitmap format. For example, the base station CU may inform the terminal that symbols 3, 4, and 5 within the slot are deactivated by informing the terminal of a bitmap ‘11100011111111’.

Unlike in the case where the RIS is activated, only a direct channel h_{BS-UE} may exist in a radio channel in the period of symbols where the RIS is deactivated. Accordingly, a signal in the period of the symbols may pass through a different wireless channel from a signal of other symbols in the slot. Here, a wireless channel when the RIS is activated may be a form in which the direct channel h_{BS-UE} and a reflected channel h_{BS-RIS-UE} are combined, i.e. h_{BS-RIS-UE}+h_{BS-UE.}

Therefore, the base station DU may allocate data during the period of RIS deactivation symbols in addition to the reference signal. In certain embodiments, the terminal may apply separate channel estimations and equalizations for the RIS activation symbols and the RIS deactivation symbols. As a result, implementation complexity may increase. To solve this, the base station may omit allocation of data to the RIS deactivation symbols. In this regard, the present disclosure will describe several embodiments.

In many embodiments, the base station may reconfigure the terminal to allocate data to the RIS deactivation symbols within the slot through an RRC message. Accordingly, the terminal may be reconfigured to allocate data to the RIS deactivation symbols within the slot through the RRC message. In certain embodiments, the base station may reconfigure the terminal not to allocate data to the RIS deactivation symbols within the slot through an RRC message. Accordingly, the terminal may be reconfigured not to allocate data to the RIS deactivation symbols within the slot through the RRC message.

Meanwhile, the base station may reconfigure whether or not to allocate data in the RIS deactivation symbols through control information. When terminal does not receive the control information, the terminal may operate according to the previous configuration.

In several embodiments, the base station and the terminal may operate in a default mode in which data is not allocated to the RIS deactivation symbols within the slot. When allocating data to the RIS deactivation symbols, the base station may inform the terminal of this through control information.

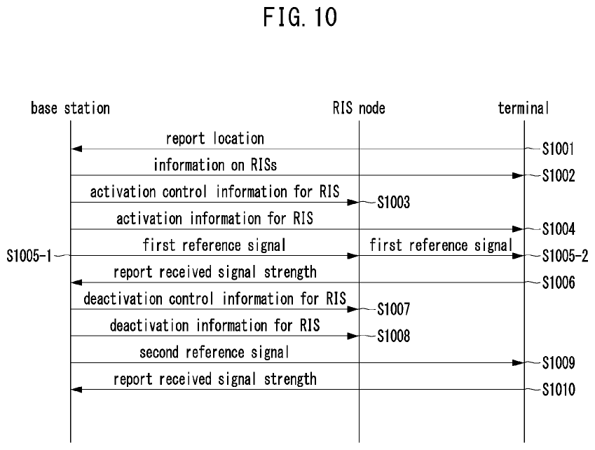

FIG. 10 is a sequence diagram illustrating a communication method through a reconfigurable intelligent surface in accordance with an embodiment.

Referring to FIG. 10, the terminal may determine its location using GPS satellites, or the like, and the terminal may report its location to the base station (S1001). Then, the base station may identify the location of the terminal by receiving information on the location of the terminal from the terminal. Accordingly, the base station may allocate a RIS to be used for communication with the terminal. In addition, the base station may inform the terminal of the RIS allocated to the terminal (S1002). The terminal may receive and manage information on the RIS allocated by the base station. Here, the information on the RIS may be an ID of the RIS (i.e. RIS ID).

Meanwhile, the base station may transmit control information (i.e. activation control information) for configuring an activation state for each frequency band supported by the RIS corresponding to each of the RIS controllers through a wired or wireless control link (S1003). Then, each of the RIS controllers may receive the control information for configuring the activations state for each frequency band supported by the RIS from the base station.

When transmitting the activation control information to each of the RIS controllers through a wireless control link, the base station may use RRC signaling, MAC CE message, and/or DCI, among others. However, exemplary embodiments of the present disclosure are not limited thereto. The activation control information for each frequency band transmitted to each of the RIS controllers may include one or more of the following.

a) The activation control information may include the RIS ID of the RIS.

b) The activation control information may include activation indication information of the RIS node.

c) The activation control information may include information on an application time of activation indication. Here, the information on the application time may be, for example, a difference between a slot index at a time when the base station CU indicates activation to the RIS controller and a slot index at a time when the transmitted activation indication is applied.

d) The activation control information may include information on a reflection coefficient of the RIS. The base station CU may adjust a power of signals reflected by the RIS by adjusting the reflection coefficient of the RIS. For example, the reflection coefficient may be set to a value (e.g., a value between 0 and 1) representing the actual reflected signal power compared to the maximum power that can be reflected. The RIS configured with a reflection coefficient of 1 can reflect received signals at the maximum reflection power. Additionally, the RIS configured with a reflection coefficient of 0.5 can reflect received signals at half the maximum reflection power.

e) The activation control information may include activation information for each reflecting element of the RIS. This control information may be information used to control each of the reflecting elements of the RIS. According to this control information, the RIS controller may activate only some reflecting elements of the RIS to form reflected beams of various beam widths and shapes.

f) The activation control information may include information on a beam width and a reflection direction of a reflected signal of the RIS.

g) The activation control information may include information on a setting value (e.g. phase value) for each activated reflecting element of the RIS.

Accordingly, the RIS controller may (re)configure the state of each frequency band of the RIS according to the activation control information received from the base station CU.

Meanwhile, the base station may transmit information on activation states of RISs deployed within a serving cell to the terminal (S1004). Then, the terminal may receive the information on the activation or deactivation states of RISs from the base station.

In certain embodiments, the information on the activation states of the RISs may include information on a start time of activation, information on an activation periodicity, information on an activation duration, and the like for each RIS. The information on the deactivation states of the RISs may include information on a start time of deactivation, information on a deactivation periodicity, information on a deactivation duration, and the like for each RIS. Here, the base station may use at least one of RRC signaling, MAC CE, DCI, and the like as a message delivering the information, without being limited thereto. Here, the start time of activation (or deactivation) of the RIS may be defined by a reference time and an offset value from the reference time.

The base station may generate a first reference signal by considering the RIS ID of the RIS allocated for communication with the terminal and the activation state of the corresponding RIS. Here, the base station may generate a scrambling sequence used to generate the reference signal according to the RIS ID of the RIS. The base station may allocate guard symbol(s) to a boundary where the state of the RIS changes. Additionally, the base station CU may inform the terminal whether guard symbol(s) are actually allocated through RRC signaling, MAC CE, DCI, and/or the like.

Thereafter, the base station may transmit the first reference signal to the RIS node (S1005-1). Then, the RIS node may receive the first reference signal from the base station and reflect it to the terminal (S1005-2). Accordingly, the terminal may receive the first reference signal from the base station via the RIS node. Then, the terminal may measure a received signal strength for the first reference signal and report it to the base station (S1006). Then, the base station may estimate a channel state by receiving the received signal strength for the first reference signal from the terminal.

Meanwhile, during the activation period of the RIS, the base station may aperiodically configure the RIS to a deactivated state during a specific slot or some symbols within a specific slot in order to separately estimate channels for a direct link and a reflected link. In certain embodiments, when transitioning the RIS to a deactivated state during a specific slot or some symbols within a specific slot, the base station may inform the terminal of this through deactivation control information (S1007). Then, the RIS node may receive the deactivation control information from the base station. Accordingly, the RIS node may deactivate the RIS during a specific slot or some symbols within a specific slot according to the deactivation control information.

Meanwhile, the base station may deliver information on the deactivation states of the RISs deployed within the serving cell to the terminal (S1008). Then, the terminal may receive information on the activation or deactivation states for the RISs from the base station.

In certain embodiments, the information on the deactivation state of the RIS may include information on a specific slot in which the RIS is deactivated or some symbols within the specific slot. Here, the base station may use RRC signaling, MAC CE, DCI, among others as a scheme of delivering a message to provide this information. Here, a start time of deactivation of the RIS may be defined by a reference time and an offset value from the reference time.

The base station may generate a second reference signal by considering the RIS ID of the RIS allocated for communication with the terminal and the activation state of the corresponding RIS. Here, the base station may generate a scrambling sequence used to generate the reference signal according to the RIS ID of the RIS. The base station may allocate guard symbol(s) to a boundary where the state of the RIS changes. Additionally, the base station CU may inform the terminal whether guard symbol(s) are actually allocated through RRC signaling, MAC CE, DCI, and/or the like.

Thereafter, the base station may transmit the second reference signal to the terminal (S1009). Then, the terminal may receive the second reference signal from the base station, and measure a received signal strength for the second reference signal and report it to the base station (S1010). Then, the base station may estimate a channel state by receiving the received signal strength for the second reference signal from the terminal.

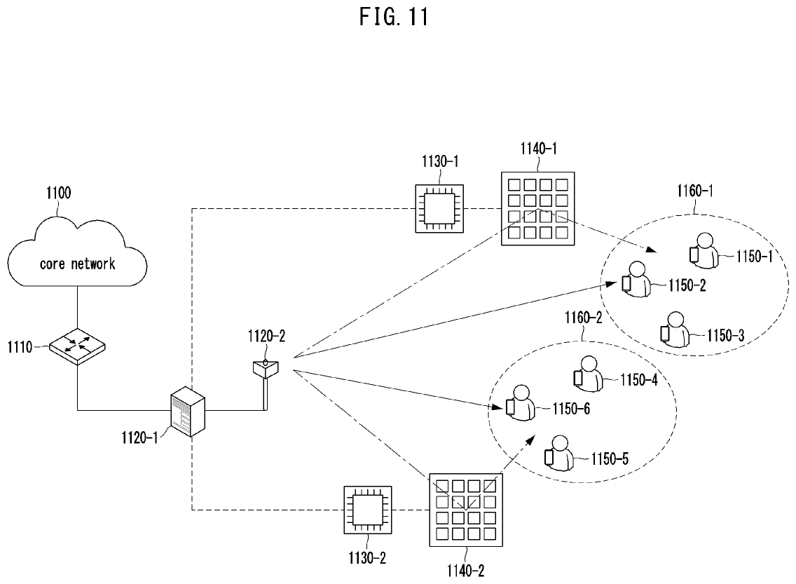

FIG. 11 is a conceptual diagram illustrating a method for grouping terminals and allocating reconfigurable intelligent surfaces in accordance with an embodiment.

Referring to FIG. 11, a communication system may include a core network 1100, a gateway 1110, a base station CU 1120-1, a base station DU 1120-2, RIS controllers 1130-1 and 1130-2, RISs 1140-1 and 1140-2, and terminals 1150-1 to 1150-6. Here, the base station CU 1120-1 and the base station DU 1120-2 may provide a base station.

The base station may collect location information of the RISs from the corresponding RIS controllers within a coverage. In addition, the base station may collect location information of the terminals from the terminals within the coverage. Here, the location information may be GPS-based location information, zone ID in case of sidelink communication, and/or the like.

Accordingly, the base station may group the terminals within the coverage based on the location information received from the terminals. For example, the base station may group the first terminal 1150-1, second terminal 1150-2, and third terminal 1150-3 into a first terminal group 1160-1. In addition, the base station may group the fourth terminal 1150-4, fifth terminal 1150-5, and sixth terminal 1150-6 into a second terminal group 1160-2. As described above, each of the terminal groups may be composed of one or more terminals. Then, the base station may allocate one or more RIS to each terminal group. For example, the base station may allocate the first RIS 1140-1 to the first terminal group and the second RIS 1140-2 to the second terminal group. In certain embodiments, the base station may perform reallocation of the RIS for each terminal group on a slot basis in the same manner as resource scheduling.

Meanwhile, the base station may request the terminal to measure and report channel states of a serving RIS node and a target RIS node for RIS reallocation. The terminal may receive a measurement report request for the serving RIS node and the target RIS node from the base station. Accordingly, the terminal may receive signals through the serving RIS node and the target RIS node for RIS reallocation by the base station, measure the channel states, and report them to the base station. Then, the base station may receive channel state information for the serving RIS node and the target RIS node from the terminal. The base station may allocate the serving RIS to the terminal when the channel state of the serving RIS is good based on the channel state information of the serving RIS and target RIS received from the terminal. In certain embodiments, the base station may allocate the target RIS to the terminal when the channel state of the target RIS received from the terminal is better than the channel state of the serving RIS.

The above-described scheme in which the base station allocates an RIS node to terminal(s) may be a default mode. In certain embodiments, a method in which a terminal selects an appropriate RIS node based on the channel states measured by itself and requests the base station to allocate the corresponding RIS node may be used. When there is such a request, the base station may allocate the RIS according to the terminal's request. Here, when the terminal may be included in the first terminal group, the first RIS may be a serving RIS node, and the second RIS may be a target RIS node. On the other hand, when the terminal is included in the second terminal group, the first RIS may be a target RIS node, and the second RIS may be a target RIS node.

The base station may allocate a reference signal (e.g. DMRS, CSI-RS) so that the terminal can measure a strength of a signal received through each of the serving RIS node and the target RIS node. The activation states of the serving RIS node and target RIS node at the time the reference signal is allocated may be controlled.

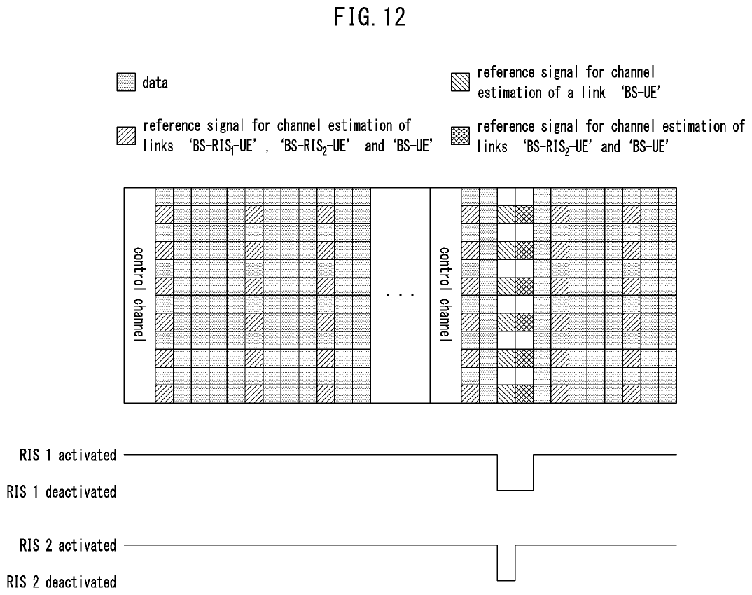

FIG. 12 is a conceptual diagram illustrating aperiodic state change of a reconfigurable intelligent surface in accordance with an embodiment.

Referring to FIG. 12, during the activation period of the RIS, the base station may aperiodically configure the RIS to an inactive state during a specific slot or some symbols within a specific slot in order to separately estimate channels for a direct link and a reflected link. If a time required for state switching of the RIS cannot be covered by a CP, the base station may additionally allocate guard symbol(s).

In addition to a basic reference signal (hereinafter, referred to as ‘first reference signal’), the base station may allocate two additional reference signals (hereinafter, referred to as ‘second reference signal’ and ‘third reference signal’) within the same slot. The base station may transmit the additional reference signals to the first RIS, second RIS, terminal, and the like. Then, the first RIS may receive the first and third reference signals and reflect them to the terminal. Accordingly, the terminal may receive the first reference signal and the third reference signal through the first RIS. In addition, the second RIS may receive the first reference signal and the second reference signal and reflect them to the terminal. Accordingly, the terminal may receive the first reference signal and the second reference signal through the second RIS. In addition, the terminal may receive the first, second, and third reference signals directly from the base station.

Accordingly, the terminal may calculate a first channel state h₁ by measuring the first reference signal received via the first RIS, the first reference signal received via the second RIS, and the first reference signal received directly from the base station. Here, the first channel state may be expressed as h₁=h_{BS-RIS1-UE}+h_{BS-RIS2-UE}+h_{BS-UE}. Here, h_{BS-RIS1-UE} may be a channel state between the base station, the first RIS, and the terminal, h_{BS-RIS2-UE} may be a channel state between the base station, the second RIS, and the terminal, and h_{BS-UE} may be a channel state between the base station and the terminal.

The terminal may measure h_{BS-UE} by measuring the second reference signal received directly from the base station.

In addition, the terminal may calculate a second channel state h₂ by measuring the third reference signal received via the second RIS and the third reference signal received directly from the base station. Here, the second channel state may be expressed as h₂=h_{BS-RIS2-UE}+h_{BS-UE}. Here, h_{BS-RIS2-UE} may be a channel state between the base station, the second RIS, and the terminal, and h_{BS-UE} may be the channel state between the base station and the terminal.

The terminal may use the estimated channel states to derive a channel value ĥ₁=h_{BS-RIS1-UE} of a link received through the first RIS and a channel value ĥ₂=h_{BS-RIS2-UE} of a link received through the second RIS. The terminal may use them to calculate received signal strength measurement values such as reference signal received powers (RSRPs) and report them to the base station periodically.

For example, a signal strength for the received signal ĥ₁=h_{BS-RIS1-UE} may be a signal strength for a signal obtained by subtracting the received signal h_{BS-UE} from the received signal h_{BS-RIS1-UE}+h_{BS-UE}.

On the other hand, in addition to a basic reference signal (hereinafter, referred to as ‘first reference signal’), the base station may allocate two additional reference signals (hereinafter, referred to as ‘second reference signal’ and ‘third reference signal’) within the same slot. The base station may transmit the additional reference signals to the first RIS, second RIS, terminal, and the like. Then, the first RIS may receive the first and third reference signals and reflect them to the terminal. Accordingly, the terminal may receive the first reference signal and the third reference signal through the first RIS. In addition, the second RIS may receive the second reference signal and reflect it to the terminal. Accordingly, the terminal may receive the second reference signal through the second RIS. In addition, the terminal may receive the first, second, and third reference signals directly from the base station.

Accordingly, the terminal may calculate a first channel state h₁ by measuring the first reference signal received through the first RIS and the first reference signal received directly from the base station. Here, the first channel state may be expressed as h₁=h_{BS-RIS1-UE}+h_{BS-UE}. Here, h_{BS-RIS1-UE} may be a channel state between the base station, the first RIS, and the terminal, and h_{BS-UE} may be a channel state between the base station and the terminal.

The terminal may measure h_{BS-UE} by measuring the second reference signal received directly from the base station.

In addition, the terminal may calculate a second channel state h₂ by measuring the third reference signal received through the second RIS and the third reference signal received directly from the base station. Here, the second channel state may be expressed as h₂=h_{BS-RIS2-UE}+h_{BS-UE}. Here, h_{BS-RIS2-UE} may be a channel state between the base station, the second RIS, and the terminal, and h_{BS-UE} may be a channel state between the base station and the terminal.

The terminal may use the estimated channel states to derive a channel value ĥ₁=h_{BS-RIS1-UE} of a link received through the first RIS and a channel value ĥ₂=h_{BS-RIS2-UE} of a link received through the second RIS. The terminal may calculate received signal strength measurement values, such as RSRPs, and report them to the base station periodically.

In certain embodiments, it is exemplified to report the signal strengths of signals received through two RIS using the finally derived channel values ĥ₁ and ĥ₂, but various other methods such as a method of measuring signal strengths using \tilde{h}₁=h_{BS-RIS1-UE}+h_{BS-UE} and \tilde{h}₂=h_{BS-RIS2-UE}+h_{BS-UE} may be used. The base station may reallocate the groups of terminals and the RIS nodes associated with them based on the received signal strength information for each RIS node reported by the terminal.

Meanwhile, the base station may allocate one or more synchronization signal blocks (SSBs) within an SSB burst set to the same beam. The base station may apply different RIS states to SSBs transmitted through the same beam. Here, the state of RIS may be configured according to control information received from the base station through the control link.

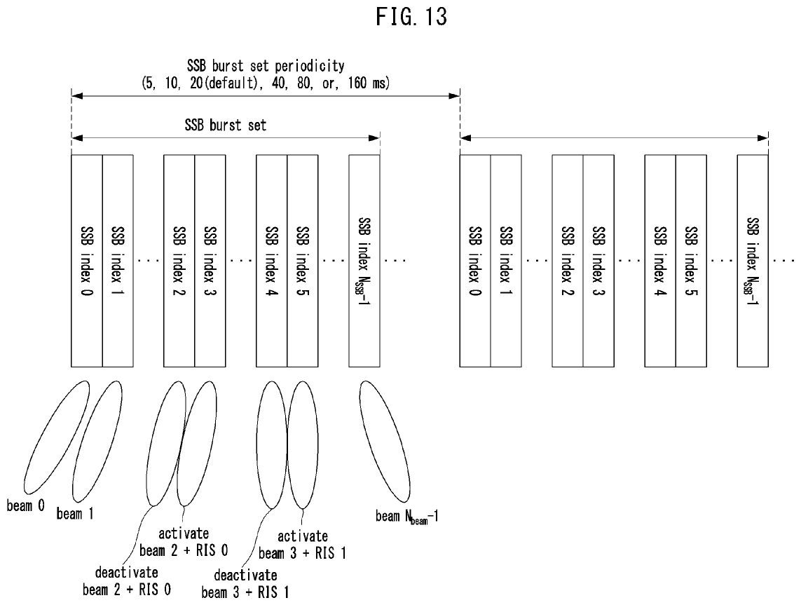

FIG. 13 is a conceptual diagram illustrating a method for allocating a transmission beam and a reconfigurable intelligent surface for each synchronization signal block in accordance with an embodiment.

Referring to FIG. 13, the base station may transmit an SSB 2 and an SSB 3 using a beam 2. The base station may configure a state of a RIS 0 when transmitting the SSB 2 to a deactivated state and the state of the RIS 0 when transmitting the SSB 3 to an activated state to reflect the SSBs in specific directions. Accordingly, the SSB 2 transmitted through the beam 2 may be transmitted without being reflected by the RIS, and the SSB 3 transmitted through the beam 2 may be transmitted by being reflected by the RIS. The similar scheme may be applied to SSBs 4 and 5. In an initial access procedure, the terminal may determine an initial transmission beam of the base station and an initial RIS node suitable for itself by receiving SSB(s) and report them to the base station in an explicit/implicit manner. In the step of determining the initial transmission beam of the base station and initial RIS node through the initial access procedure, considering the limited SSB burst resources, only a subset of configurable overall states of the RIS node may be utilized.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method performed by a base station, comprising:
transmitting, to a first reconfigurable intelligent surface (RIS) node, first control information for the first RIS node;
transmitting, to a terminal, first information of the first RIS node based on the first control information; and
transmitting a first signal to the first RIS node and the terminal while the first RIS node is in an activated state according to the first control information,
wherein the first signal is transmitted to the terminal through a path reaching the terminal from the base station via the first RIS node and a path directly reaching the terminal from the base station.

2. The method according to claim 1, wherein the first control information includes at least one of information on an identifier (ID) of the first RIS node, information on a start time of activation of the first RIS node, information on an activation periodicity of the first RIS node, information on an activation duration of the first RIS node, information on a start time of deactivation of the first RIS node, information on a deactivation periodicity of the first RIS node, information on a deactivation duration of the first RIS node, information on a reflection coefficient of the first RIS node, information indicating activation of one or more reflecting element of the first RIS node, information indicating deactivation of one or more reflecting element of the first RIS node, information on a beam width and a reflection direction of a reflected signal of the first RIS node, or information on a setting value for one or more activated reflecting element of the first RIS node.

3. The method according to claim 1, wherein the first information includes at least one of information on a start time of activation of the first RIS node, information on an activation periodicity of the first RIS node, information on an activation duration of the first RIS node, information on a start time of deactivation of the first RIS node, information on a deactivation periodicity of the first RIS node, or information on a deactivation duration of the first RIS node.

4. The method according to claim 3, wherein the information on the start time of activation of the first RIS node includes information on a reference time and information on an offset from the reference time.

5. The method according to claim 1, wherein the first control information is transmitted to the terminal through at least one of radio resource control (RRC) signaling, a medium access control (MAC) control element (CE) message, or downlink control information (DCI).

6. The method according to claim 1, further comprising:
setting a time when the first RIS node is in a deactivated state;
transmitting, to the first RIS node, second control information on the time when the first RIS node is in the deactivated state;
transmitting, to the terminal, second information of the first RIS node based on the second control information; and
transmitting a second signal to the terminal while the first RIS node is in the deactivated state,
wherein the second signal is transmitted to the terminal through a path directly reaching the terminal from the base station.

7. The method according to claim 1, further comprising: transmitting a third signal to a second RIS node and the terminal while the first RIS node is in a deactivated state and the second RIS node is in an activated state,
wherein the third signal is transmitted to the terminal through a path directly reaching the terminal from the base station and a path reaching the terminal via the second RIS node.

8. The method according to claim 7, further comprising:
receiving, from the terminal, information on a first signal strength for the first signal and information on a second signal strength for the third signal; and
changing a serving RIS from the first RIS node to the second RIS node based on the first signal strength and the second signal strength.

9. The method according to claim 1, further comprising:
transmitting the first signal to a second RIS node while the first RIS node is in an activated state, wherein the first signal is transmitted to the terminal through a path via the first RIS node, a path via the second RIS node, and a path directly reaching the terminal;
transmitting a fourth signal to the terminal while the first RIS node and the second RIS node are in deactivated states; and
transmitting a fifth signal to the second RIS node and the terminal while the first RIS node is in a deactivated state and the second RIS node is in an activated state,
wherein the fifth signal is received by the terminal through a path directly reaching the terminal from the base station and a path reaching the terminal via the second RIS node.

10. The method according to claim 9, further comprising:
receiving, from the terminal, information on a third signal strength for the first signal based on at least one of the first signal, the fourth signal, or the fifth signal, and information on a fourth signal strength for the fifth signal based on at least one of the fourth signal or the fifth signal; and
changing a serving RIS from the first RIS node to the second RIS node based on the third signal strength and the fourth signal strength.

11. A method performed by a terminal, comprising:
receiving, from a base station, first information of a first reconfigurable intelligent surface (RIS) node;
receiving a first reception signal from the first RIS node and the base station while the first RIS node is in an activated state based on the first information;
receiving a second reception signal from the base station while the first RIS node is in a deactivated state;
calculating a first received signal strength based on the first reception signal and the second reception signal; and
transmitting information on the calculated first received signal strength to the base station,
wherein the first reception signal is a first signal transmitted by the base station, that is received through a path reaching the terminal from the base station via the first RIS node and a path directly reaching the terminal from the base station, and the second reception signal is a second signal transmitted by the base station, that is received through a path directly reaching the terminal from the base station.

12. The method according to claim 11, wherein the first received signal strength is the strength of a signal obtained by subtracting the second reception signal from the first reception signal.

13. The method according to claim 11, wherein the first information includes at least one of information on a start time of activation of the first RIS node, information on an activation periodicity of the first RIS node, information on an activation duration of the first RIS node, information on a start time of deactivation of the first RIS node, information on a deactivation periodicity of the first RIS node, or information on a deactivation duration of the first RIS node.

14. The method according to claim 11, further comprising:
receiving a third reception signal from the first RIS node, a second RIS node, and the base station while the first RIS node and the second RIS node are in activated states;
receiving a fourth reception signal from the second RIS node and the base station while the first RIS node is in a deactivated state and the second RIS node is in an activated state;
receiving a fifth reception signal from the base station while the first RIS node and the second RIS node are in deactivated states;
calculating a second received signal strength by considering at least one of the first reception signal, the third reception signal, the fourth reception signal, or the fifth reception signal;
calculating a third received signal strength by considering at least one of the fourth reception signal or the fifth reception signal; and
transmitting information on the second received signal strength and the third received signal strength to the base station,
wherein the third reception signal is a third signal transmitted by the base station, which is received by the terminal through a path via the first RIS node, a path via the second RIS node, and a path directly reaching the terminal from the base station, the fourth reception signal is a fourth signal transmitted by the base station, which is received through a path via the second RIS node and a path directly reaching the terminal from the base station, and the fifth reception signal is a fifth signal transmitted by the base station, which is received through a path directly reaching the terminal from the base station.

15. A terminal for facilitating communication in a wireless network, the terminal comprising:
a memory; and
a processor coupled to the memory, the processor configured to cause:
receiving, from a base station, first information of a first reconfigurable intelligent surface (RIS) node;
receiving a first reception signal from the first RIS node and the base station while the first RIS node is in an activated state based on the first information;
receiving a second reception signal from the base station while the first RIS node is in a deactivated state;
calculating a first received signal strength based on the first reception signal and the second reception signal; and
transmitting information on the calculated first received signal strength to the base station,
wherein the first reception signal is a first signal transmitted by the base station, which is received through a path reaching the terminal from the base station via the first RIS node and a path directly reaching the terminal from the base station, and the second reception signal is a second signal transmitted by the base station, which is received through a path directly reaching the terminal from the base station.

16. The terminal according to claim 15, wherein the first received signal strength is the strength of a signal obtained by subtracting the second reception signal from the first reception signal.

17. The terminal according to claim 15, wherein the first information includes at least one of information on a start time of activation of the first RIS node, information on an activation periodicity of the first RIS node, information on an activation duration of the first RIS node, information on a start time of deactivation of the first RIS node, information on a deactivation periodicity of the first RIS node, or information on a deactivation duration of the first RIS node.

18. The terminal according to claim 15, wherein the processor is further configured to cause:
receiving a third reception signal from the first RIS node, a second RIS node, and the base station while the first RIS node and the second RIS node are in activated states;
receiving a fourth reception signal from the second RIS node and the base station while the first RIS node is in a deactivated state and the second RIS node is in an activated state;
receiving a fifth reception signal from the base station while the first RIS node and the second RIS node are in deactivated states;
calculating a second received signal strength by considering at least one of the first reception signal, the third reception signal, the fourth reception signal, or the fifth reception signal;
calculating a third received signal strength by considering at least one of the fourth reception signal or the fifth reception signal; and
transmitting information on the second received signal strength and the third received signal strength to the base station,
wherein the third reception signal is a third signal transmitted by the base station, which is received by the terminal through a path via the first RIS node, a path via the second RIS node, and a path directly reaching the terminal from the base station, the fourth reception signal is a fourth signal transmitted by the base station, which is received through a path via the second RIS node and a path directly reaching the terminal from the base station, and the fifth reception signal is a fifth signal transmitted by the base station, which is received through a path directly reaching the terminal from the base station.
